(19) United States
(12) Patent Application Publication
(10) Pub. No.: US 2015/0006669 A1
(43) Pub. Date: Jan. 1, 2015

(54) SYSTEMS AND METHODS FOR DIRECTING INFORMATION FLOW

(71) Applicant: Google Inc., Mountain View, CA (US)

(72) Inventors: Alejandro Kauffmann, San Francisco, CA (US); Christian Plagemann, Menlo Park, CA (US)

(21) Appl. No.: 13/932,379

(22) Filed: Jul. 1, 2013

(51) Int. Cl. H04L 29/08

(52) U.S. Cl. CPC H04L 67/10
USPC 709/217

(57) ABSTRACT

The disclosed technology may include systems, methods, and apparatus for directing information flow. According to an example implementation, a method is provided that includes receiving, at a first server, identification information for one or more computing devices capable of communication with the first server; receiving one or more images and an indication of a gesture performed by a first person; associating a first computing device with the first person; identifying a second computing device; determining, based on the indication of the gesture and on the received identification information that the gesture is associated with an intent to transfer information between the first computing device and the second computing device, and which from among the first and second computing devices is an intended recipient device; and sending, to the intended recipient device, content information associated with a user credential of the first person.

### BACKGROUND

The ability to easily store, access, and share information (data, files, media, etc.) between computing devices is an ongoing issue that has only been partially addressed by data sharing and cloud storage services. For example, such services attempt to ease the data-sharing problem by providing a single online cloud repository that is synced across all registered devices. However, regardless of where the information is stored, there is still a need to easily move or share data, files, media, assets, and/or documents that are on one device onto or with another device.

### SUMMARY

Some or all of the above needs may be addressed by certain implementations of the disclosed technology. Certain implementations may include systems and methods for directing information among computing devices.

According to an example implementation, a computer-implemented method is provided for directing information flow. The method includes receiving, at a first server, identification information for one or more computing devices capable of communication with the first server; receiving, at the first server, one or more images and an indication of a gesture performed by a first person; associating, based at least in part on the one or more images, a first computing device of the one or more computing devices with the first person; identifying, based at least in part on the one or more images, a second computing device of the one or more computing devices; determining, based on the indication of the gesture and on the received identification information for the one or more computing devices: that the gesture is associated with an intent to transfer information between the first computing device and the second computing device; and which from among the first and second computing devices is an intended recipient device; and sending, to the intended recipient device, content information associated with a user credential of the first person.

According to another example implementation, a system is provided. The system includes a memory for storing data and computer-executable instructions; an imaging device; and at least one processor in communication with the imaging device, the at least one processor configured to access memory, wherein the at least one processor is further configured to execute the computer-executable instructions to cause the system to: receive, at a first server, identification information for one or more computing devices capable of communication with the first server; receive, at the first server and from the imaging device, one or more images and an indication of a gesture performed by a first person; associate, based at least in part on the one or more images, a first computing device of the one or more computing devices with the first person; identify, based at least in part on the indication of the gesture, a second computing device of the one or more computing devices; determine, based on the indication of the gesture and on the received identification information for the one or more computing devices: that the gesture is associated with an intent to transfer information between the first computing device and the second computing device; and which from among the first and second computing devices is an intended recipient device; and send, to the intended recipient device, content information associated with a user credential of the first person.

According to another example implementation, a computer-readable medium is provided that stores instructions, that when executed by a computer device having one or more processors, cause the computer device to perform a method. The method includes receiving, at a first server, identification information for one or more computing devices capable of communication with the first server; receiving, at the first server and from at least one imaging device, one or more images and an indication of a gesture performed by a first person; associating, based at least in part on the one or more images, a first computing device of the one or more computing devices with the first person; identifying, based at least in part on the one or more images, a second computing device of the one or more computing devices; determining, based on the indication of the gesture and on the received identification information for the one or more computing devices: that the gesture is associated with an intent to transfer information between the first computing device and the second computing device; and which from among the first and second computing devices is an intended recipient device; and sending, to the intended recipient device, content information associated with a user credential of the first person.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of an illustrative information transferring system according to an example implementation.

FIG. 2A is an illustrative diagram depicting directing information among computing devices, according to an example implementation.

FIG. 2B is another illustrative diagram depicting directing information among computing devices, according to an example implementation.

FIG. 2C is an illustrative diagram depicting directing information among computing devices, based on a recognition, according to an example implementation.

FIG. 2D is another illustrative diagram depicting directing information among computing devices according to an example implementation.

FIG. 3 is a block diagram of an illustrative system or processor, according to an example implementation.

FIG. 4 is a flow diagram of a method according to an example implementation.

### DETAILED DESCRIPTION

Some implementations of the disclosed technology will be described more fully hereinafter with reference to the accompanying drawings. This disclosed technology may, however, be embodied in many different forms and should not be construed as limited to the implementations set forth herein.

Certain implementations of the disclosed technology may enable gesture recognition and/or other contextual cues (including face recognition) for accessing and/or sharing stored information. According to an example implementation, spatial cues from one or more users may be captured with an imaging device and interpreted for executing the sharing of data (or links to the data) and directing the direction of the sharing. In certain example implementations, a server may maintain the state information of devices in the system. In certain example implementations, the server may keep and update a database of device identification information for devices that have been in communication with the server, or that have been detected by the server.

In the following description, numerous specific details are set forth. However, it is to be understood that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

In some instances, a computing device may be referred to as a mobile device, mobile computing device, a mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, imaging device, or some other like terminology. In other instances, a computing device may be one or more processors, controllers, or a central processing unit (CPU). In yet other instances, a computing device may be a set of hardware components.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

According to an example implementation, client software may be utilized to handle communications between devices and the server. In certain example implementations of the disclosed technology, one or more depth/RGB cameras, together with tracker/gesture/recognition software may be utilized to perform one or more of the following: (1) determine spatial relationships between the devices; (2) determine gesture intent; (3) determine a desired direction of information flow from the gesture; (4) recognize an identity of a user based on one or more images; and (5) interpret contextual clues from information obtained in the camera field view.

For example, a first user may be listening to a song on their entertainment device, and the first person may desire to share the song (or link to the song) with one of the contacts on the first user's phone. In one example implementation, the server may receive information such as the state information of the phone, the identification of the song that is playing on the entertainment device, and the contact information on the phone. In one example implementation, the first user may signify the desire for information sharing (and direction) in a number of different ways. For example, the phone may be held in a direction towards the entertainment center, with the phone screen facing the user. In one example implementation, the camera may capture images of an outstretched arm, and the images may be interpreted by a processor to determine a gesture with a certain direction. In an example implementation, upon detection of the gesture, information from the phone (for example, from accelerometers, light detectors etc.) may be analyzed to see if its sensors have detected movement consistent with being held out and, if so, an orientation of the phone.

According to certain example implementations, the orientation of the phone may signify whether the phone is in pull or push mode. For example, upon determining that the phone is in pull mode and is pointed at the entertainment device, the server may be utilized to receive and interpret state information for the phone and the entertainment device. In this example scenario, a contact application associated with the phone may handle the pull messages by sharing song links with the desired contact. In an example implementation, the link to the song may be sent, but not the actual song.

According to an example implementation, a depth camera on the phone and/or associated with a separate device, may be used to recognize information including but not limited to spatial clues, gestures, faces of a contact for which a user wishes to send information, etc. For example, in one example implementation, the recognition of the contact may act as a proxy for the contact person's device, and information may be sent to the contact person's phone in response to the recognition.

In another example implementation, a first person may point her device toward a second person to share data with the second person. For example, in one implementation, camera facial recognition may be utilized to determine the identity the second person, and the system may send the data to an account associated with the second person (based on determining the identity), so that when the second person goes into his account, he may access the shared data. In this example implementation, it is not necessary for the second person to have access to a computing device at the time that the data is shared from the first person's device because the sharing with the second person's account may be based on the recognition of a likeness of the second person and an association of the likeness with a routing of the shared data.

Another implementation of the disclosed technology may include determining emails that a first person has exchanged with a second person by interpretation of a particular gesture. For example, the first user may point a first device in a direction of second user to initiate a command to determine emails that the first person has exchanged with the second person, or vice-versa, depending on certain gesture components, or other contextual information.

According to an example implementation, a first person may hold his mobile computing device out towards a second person, with the screen facing the first person to indicate that he wishes to receive information from the second person (or an account or user credential associated with the second person). In another example implementation, the screen on the mobile computing device may be pointed towards a second person, a device in the local environment, etc., to signify the gesture command to share data with whomever or whatever the phone is pointed towards. In certain instances, one or more prompts for an initial setup, disambiguation, and/or confirmation may be presented.

According to certain example implementations, it may be unnecessary to identify a user to initiate a transfer of information between devices. In certain example embodiments, the device (or devices) may already be associated with one or more users, and authentication may have already taken place. For example, when transferring a video call from a television screen to a mobile device, additional authentication may be unnecessary because the user may already be logged in on both devices. Therefore, certain example implementations may omit the steps of user recognition and/or authentication, particularly if these steps have already been carried out and if sufficient authentication is already in place.

According to an example implementation, each device involved in the sharing process may receive information regarding the state of the other device(s). In certain example implementations of the disclosed technology, it may not be necessary to share actual data, but instead, a reference or link to the data may be shared. Certain example implementations may utilize a cloud server, and the data may be loaded to the cloud server. In certain situations where the data has not yet been uploaded to the cloud server, a pointer (IOU) may be loaded for later sharing after the actual data is available on the cloud server. One example of this implementation may involve sharing a photo. For example, a camera application may be utilized to recognize the faces of people in a photo, and it may prompt to share with some or all of the recognized people in the photo (or prompt for information for the people who are not recognized). In one example implementation, a pointer address may be setup and loaded to a cloud server in anticipation of the photo data being uploaded in the near future, and if links to the recognized people (for example, e-mail addresses, etc.) are established, then the pointer address may be shared with the links to the recognized people so that they may have easy access to the photo once it is loaded to the cloud server.

Certain example implementations of the disclosed technology may utilize an external camera (depth, video, still etc.) to view the local environment scene. In this example implementation, the external camera may be utilized to track multiple people, their environment, physical alignment, orientation, etc. In another example implementation, if an external camera is not available, a webcam on a smartphone or laptop may be used in conjunction with other sensors (for example, accelerometers on the smartphone) to interpret contextual information and sense gesture commands. In certain example implementation, a physical connection is not necessary.

Certain example implementations of the disclosed technology may utilize a depth camera. A depth camera is a general term for a camera capable of determining the depth of an image, such as by returning position coordinates of objects in a three-dimensional space. For example, a local environment may be monitored by the depth camera. In certain example implementations of the disclosed technology, the depth camera may be utilized in conjunction with a processor and special software to monitor relative orientations, movements, and/or positions of a user's arms, head, computing device, etc., to determine and interpret a gesture command. In one example implementation, the depth camera may be an external device. In another example implementation, the depth camera may be integrated with the user's mobile computing device.

In one example implementation, a computing device's camera may be oriented to face to an actual person, and the computing device may display data having to do with that person. For example, if an e-mail program is open while the device's camera recognizes a person, then e-mails from that person may be displayed. In another example implementation, if the computing device user interface is at the home screen, then a list of various interactions with the recognized person may be displayed. For example, calendar invites, e-mails, photos, etc may be presented for selection.

Various implementations may be utilized for initiating and directing information among devices, according to example implementations of the disclosed technology, and will now be described with reference to the accompanying figures.

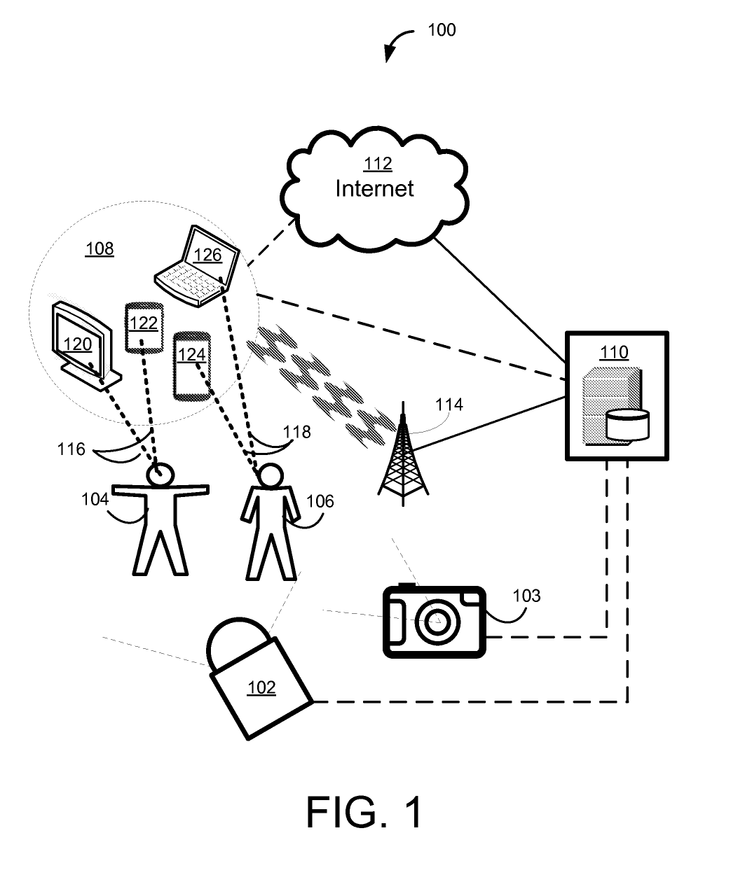

FIG. 1 shows a block diagram of an information transferring system 100 according to an example implementation of the disclosed technology. In an example implementation, a depth camera 102 and/or a video 102 or the video camera 103 may be utilized to capture images, video, and/or depth information in a local environment. In one example implementation, a first user 104 may provide a body gesture to indicate a desire to transfer information among various devices 108. In certain implementations, specific devices may be associated 116 with the first user 104. For example, and as depicted, the first user 104 may be associated 116 with a local computer 120 and a mobile computing device 122. In one example implementation, other devices (for example, a smart phone 124 and a laptop computer 126) may be associated 118 with a second user 106.

According to an example implementation of the disclosed technology, information derived from the local environment via the depth camera 102 and/or the video camera 103 may be utilized, for example, by a server 110 or other computing device (including, but not limited to one of the various devices 108 in the local environment). The server 110 may communicate with the various devices 108 a number of different ways, without limitation. In one implementation, the server 110 may be in direct communication with the various devices 108. In another implementation the various devices 108 may communicate with the server 110 via an Internet connection 112. In yet another implementation the various devices may communicate with the server via a cellular network 114. Other communication channels including Wi-Fi, Bluetooth, etc., may be utilized without departing from the scope of the disclosed technology.

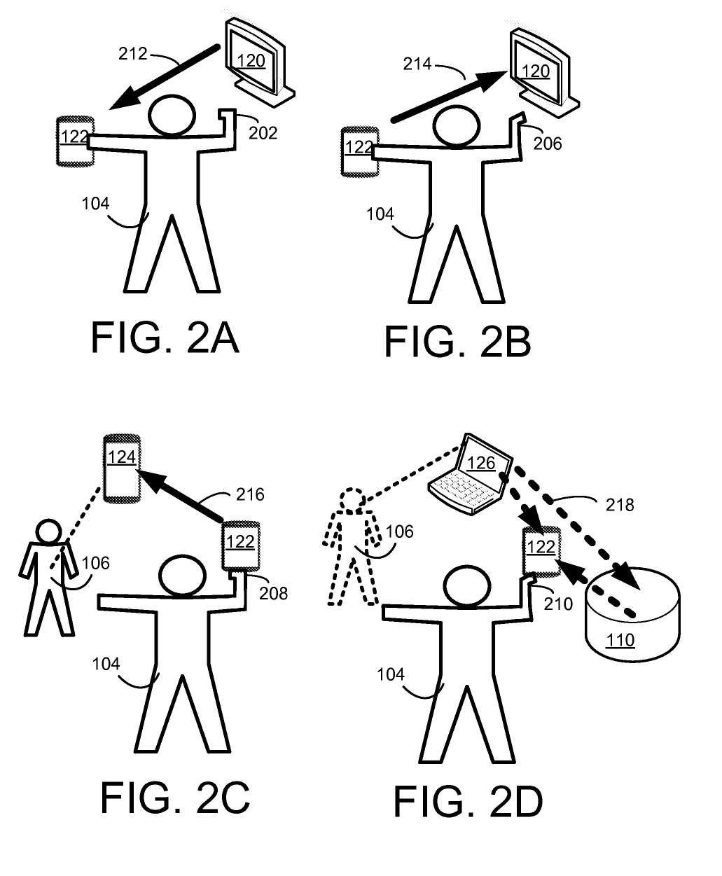

FIGS. 2A through 2D depict various exemplary scenarios in which gesture may be detected and utilized to direct the transfer of information from one device to another. In these example figures, certain body positions are depicted to provide a simplified explanation of the disclosed technology. In other example embodiments, head orientations, device orientations, facial features, body movements, etc., may be recognized and utilized for directing information flow without departing from the scope of the disclosed technology. One feature of the disclosed technology, as depicted in these figures, is the control of the direction for the flow or sharing of information. For example, a first gesture may be interpreted as an indication to send a link or content from a first device to a second device. And a second gesture may be interpreted as an indication to send a link or content from the second device to the first device. In other words, according to various implementations of the disclosed technology, contextual clues from a local environment may be utilized in conjunction with device state information to initiate information sharing between devices and to specify a particular direction of the information flow.

FIG. 2A, for example, depicts a first user 104 in the process of performing a gesture command 202. In an example implementation, the gesture command 202 may be interpreted by the system as a desire by the first user 104 to transfer information in a certain direction 212 from the local computer 120 to the mobile computing device 122. According to certain implementations of the disclosed technology, the relative orientation and/or state of the computing devices 122, 120 may be further utilized to interpret the gesture command 202.

FIG. 2B is another illustrative diagram, similar to the one shown in FIG. 2A, but in this example, a different gesture 206 may be utilized to indicate a desire by the first user 104 to transfer information in a different direction 214, for example, from the mobile computing device 122 to the local computer 120.

FIG. 2C is an illustrative diagram depicting directing information among computing devices, based on a gesture command 208 and on an identity recognition, according to an example implementation. In this example embodiment, a first user 104 associated with a first device 122, may desire to send information from the first device 122 to a second user 106. In one example implementation, facial recognition may be utilized in conjunction with the gesture 208 to determine the identity of the second user 106. In certain example implementations, information may be derived from contextual clues in the local environment to establish an association between the second user 106 and the second device 124. In other example implementations such information may be already known and may be included in the state information communicated from the various devices. In this example scenario, multiple pieces of information may be utilized to direct the information flow and direction 216. For example, a depth or video camera may be utilized to interpret the gesture command 208 from the first user 104. Similarity, contextual clues including whether or not a particular device is being held, how it is oriented, what its current state is, who it belongs to, etc., may be utilized for interpreting gesture command 208 according to example implementations of the disclosed technology.

FIG. 2D is another illustrative diagram depicting additional scenarios for directing information among computing devices, according to implementations of the disclosed technology. In this example illustration, a first user 104 may signify by a gesture command 210 the desire to transfer content or other information from a laptop 126, for example, that may be associated with a second user 106. In one example implementation a recognition of the second user 106 (as discussed above with reference to FIG. 2C) may be utilized to identify that the laptop 126 is associated with the second user. In another example implementation the contextual clues including the gesture command 210 known available devices, etc. may be utilized to initiate the data transfer. According to one example implementation the gesture command may be utilized to initiate data transfer from the laptop 126 to the first users mobile computing device 122. In another example implementation, data may be transferred 218 to a server or other cloud storage device 110 for retrieval.

It should be understood that FIGS. 2A-2D are intended to provide a few representative implementation scenarios. Various combinations and permutations involving multiple users, more or less devices, different types of computing device, various communication channels etc. may be utilized without departing from the scope of the disclosed technology.

Various implementations of the communication systems and methods herein may be embodied in non-transitory computer readable media for execution by a processor. An example implementation may be used in an application of a mobile computing device, such as a smartphone or tablet, but other computing devices may also be used, such as to portable computers, tablet PCs, Internet tablets, PDAs, ultra mobile PCs (UMPCs), etc.

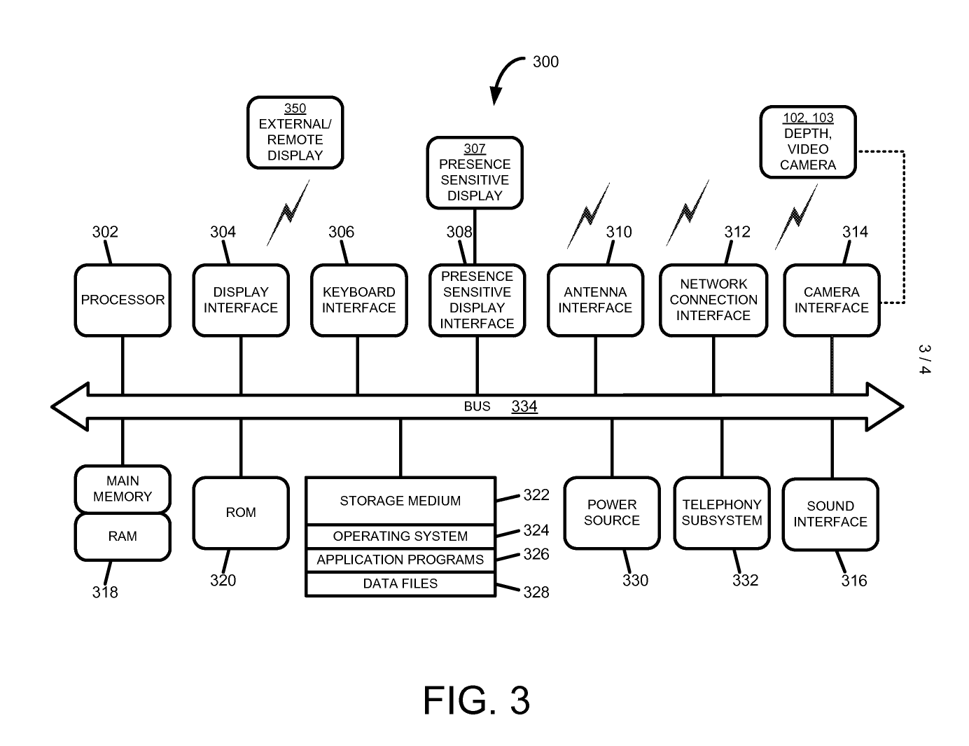

FIG. 3 depicts a block diagram of an illustrative computing device 300 according to an example implementation. Certain aspects of FIG. 3 may be embodied in the mobile device (for example, one or more of the various devices 108 as shown in FIG. 1). Certain aspects of FIG. 3 may be embodied in a server (for example, the server 110 as shown in FIG. 1). Various implementations and methods herein may be embodied in non-transitory computer readable media for execution by a processor. It will be understood that the architecture 300 is provided for example purposes only and does not limit the scope of the various implementations of the communication systems and methods.

The computing device 300 of FIG. 3 includes one or more processors where computer instructions are processed. The computing device 300 may comprise the processor 302, or it may be combined with one or more additional components shown in FIG. 3. For example, in one example embodiment, the computing device 300 may be the processor 302. In yet other example embodiments, the computing device 300 may be a mobile device, mobile computing device, a mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In other instances, a computing device may be a processor, controller, or a central processing unit (CPU). In yet other instances, a computing device may be a set of hardware components.

The computing device 300 may include a display interface 304 that acts as a communication interface and provides functions for rendering video, graphics, images, and texts on the display. In certain example implementations of the disclosed technology, the display interface 304 may be directly connected to a local display, such as a touch-screen display associated with a mobile computing device. In another example implementation, the display interface 304 may be configured for providing data, images, and other information for an external/remote display 350 that is not necessarily physically connected to the mobile computing device. For example, a desktop monitor may be utilized for mirroring graphics and other information that is presented on a mobile computing device. In certain example implementations, the display interface 304 may wirelessly communicate, for example, via a Wi-Fi channel or other available network connection interface 312 to the external/remote display 350.

In an example implementation, the network connection interface 312 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 304 may be operatively coupled to a local display, such as a touch-screen display associated with a mobile device. In another example, the display interface 304 may be configured to provide video, graphics, images, text, other information, or any combination thereof for an external/remote display 350 that is not necessarily connected to the mobile computing device. In one example, a desktop monitor may be utilized for mirroring or extending graphical information that may be presented on a mobile device. In another example, the display interface 304 may wirelessly communicate, for example, via the network connection interface 312 such as a Wi-Fi transceiver to the external/remote display 350.

The computing device 300 may include a keyboard interface 306 that provides a communication interface to a keyboard. In one example implementation, the computing device 300 may include a presence-sensitive display interface 308 for connecting to a presence-sensitive display 307. According to certain example implementations of the disclosed technology, the presence-sensitive display interface 308 may provide a communication interface to various devices such as a pointing device, a touch screen, a depth camera, etc. which may or may not be associated with a display.

The computing device 300 may be configured to use an input device via one or more of input/output interfaces (for example, the keyboard interface 306, the display interface 304, the presence sensitive display interface 308, network connection interface 312, camera interface 314, sound interface 316, etc.,) to allow a user to capture information into the computing device 300. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device 300 or may be a separate device. For example, the input device may be an accelerometer, a magnetometer, a digital camera, a microphone, and an optical sensor.

Example implementations of the computing device 300 may include an antenna interface 310 that provides a communication interface to an antenna; a network connection interface 312 that provides a communication interface to a network. As mentioned above, the display interface 304 may be in communication with the network connection interface 312, for example, to provide information for display on a remote display that is not directly connected or attached to the system. In certain implementations, a camera interface 314 is provided that acts as a communication interface and provides functions for capturing digital images from a camera. In certain implementations, a sound interface 316 is provided as a communication interface for converting sound into electrical signals using a microphone and for converting electrical signals into sound using a speaker. According to example implementations, a random access memory (RAM) 318 is provided, where computer instructions and data may be stored in a volatile memory device for processing by the CPU 302.

According to an example implementation, the computing device 300 includes a read-only memory (ROM) 320 where invariant low-level system code or data for basic system functions such as basic input and output (I/O), startup, or reception of keystrokes from a keyboard are stored in a non-volatile memory device. According to an example implementation, the computing device 300 includes a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 (including, for example, a web browser application, a widget or gadget engine, and or other applications, as necessary) and data files 328 are stored. According to an example implementation, the computing device 300 includes a power source 330 that provides an appropriate alternating current (AC) or direct current (DC) to power components. According to an example implementation, the computing device 300 includes and a telephony subsystem 332 that allows the device 300 to transmit and receive sound over a telephone network. The constituent devices and the CPU 302 communicate with each other over a bus 334.

In accordance with an example implementation, the CPU 302 has appropriate structure to be a computer processor. In one arrangement, the computer CPU 302 may include more than one processing unit. The RAM 318 interfaces with the computer bus 334 to provide quick RAM storage to the CPU 302 during the execution of software programs such as the operating system application programs, and device drivers. More specifically, the CPU 302 loads computer-executable process steps from the storage medium 322 or other media into a field of the RAM 318 in order to execute software programs. Data may be stored in the RAM 318, where the data may be accessed by the computer CPU 302 during execution. In one example configuration, the device 300 includes at least 128 MB of RAM, and 256 MB of flash memory.

The storage medium 322 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

According to one example implementation, the term computing device, as used herein, may be a CPU, or conceptualized as a CPU (for example, the CPU 302 of FIG. 3). In this example implementation, the computing device (CPU) may be coupled, connected, and/or in communication with one or more peripheral devices, such as display. In another example implementation, the term computing device, as used herein, may refer to a mobile computing device, such as a smartphone or tablet computer. In this example embodiment, the computing device may output content to its local display and/or speaker(s). In another example implementation, the computing device may output content to an external display device (e.g., over Wi-Fi) such as a TV or an external computing system.

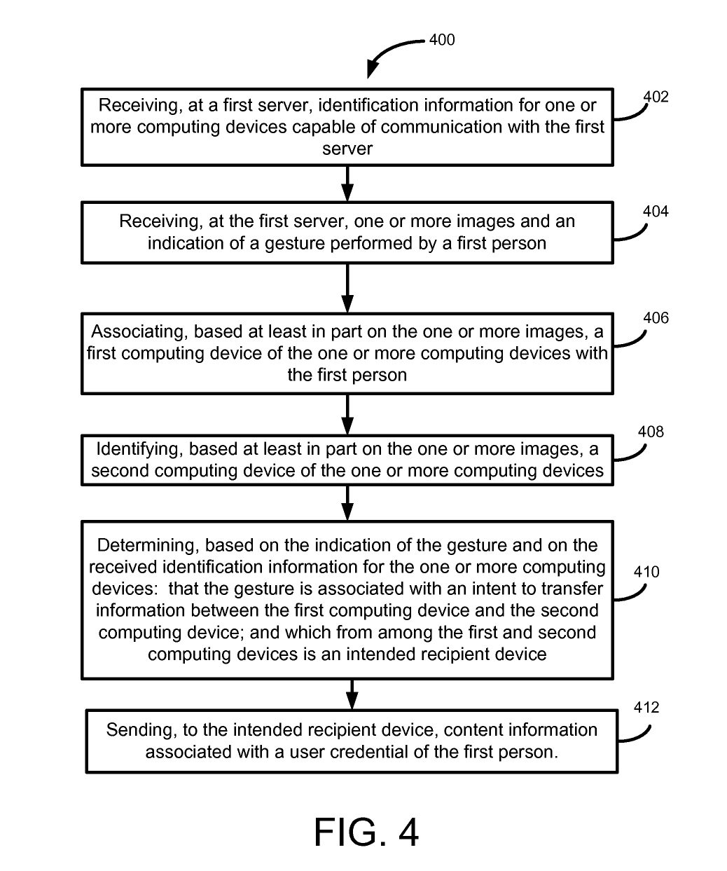

An example method 400 for directing information flow will now be described with reference to the flowchart of FIG. 4. The method 400 starts in block 402, and according to an example implementation includes receiving, at a first server, identification information for one or more computing devices capable of communication with the first server. In block 404, the method 400 includes receiving, at the first server, one or more images and an indication of a gesture performed by a first person. In block 406, the method 400 includes associating, based at least in part on the one or more images, a first computing device of the one or more computing devices with the first person. In block 408, the method 400 includes identifying, based at least in part on the one or more images, a second computing device of the one or more computing devices. In block 410, the method 400 includes determining, based on the indication of the gesture and on the received identification information for the one or more computing devices: that the gesture is associated with an intent to transfer information between the first computing device and the second computing device; and which from among the first and second computing devices is an intended recipient device. In block 412, the method 400 includes sending, to the intended recipient device, content information associated with a user credential of the first person.

In accordance with example implementations of the disclosed technology, a user credential may be defined to encompass one or more of: an account, IP address, MAC address, browser session identifier (e.g., a cookie), device ID (e.g., device serial no.), biometric info (e.g., a facial recognition analysis performed on the user's face), etc.

According to an example implementation, the method further includes receiving content and state information for the one or more computing devices. In one example implementation, the imaging device comprises a video camera. In one example implementation, the imaging device comprises a depth camera and the one or more images comprise depth information. Certain example implementations include determining, based at least in part on the one or more images, an identity associated with a second person, wherein the second computing device is associated with the second person identity. In one example implementation, the second computing device is associated with the first person identity. In one example implementation, the first computing device is the first server. In one example implementation, the second computing device is a second server. According to an example implementation, the one or more gesture indications include an orientation of the one or more computing devices. In another example implementation, the one or more gesture indications include a sequence of one or more body positions. In one example implementation, sending the content information includes sending a link to the content.

According to example implementations, certain technical effects can be provided, such as creating certain systems and methods that allow human gestures to initiate data transfer between devices. Example implementations of the disclosed technology can provide the further technical effects of providing systems and methods that allow human gestures and other contextual information for controlling a direction of information flow among computing devices.

In example implementations of the disclosed technology, the information transferring system 100 may include any number of hardware and/or software applications that are executed to facilitate any of the operations. In example implementations, one or more I/O interfaces may facilitate communication between the information transferring system 100 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the information transferring system 100. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the information transferring system 100 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

As desired, implementations of the disclosed technology may include the information transferring system 100 with more or less of the components illustrated in FIG. 1.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to mobile devices. Those skilled in the art recognize that there are several categories of mobile devices, generally known as portable computing devices that can run on batteries but are not usually classified as laptops. For example, mobile devices can include, but are not limited to portable computers, tablet PCs, Internet tablets, PDAs, ultra mobile PCs (UMPCs) and smartphones.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
receiving, at a server computer, identification information for one or more computing devices capable of communication with the server computer;
receiving, at the server computer, image data associated with one or more images, the image data including:
an indication of a current state of an environment of at least one of the one or more computing devices, and
an indication of a gesture performed by a first person;
associating, by the server computer, based at least in part on the image data associated with the one or more images, a first computing device of the one or more computing devices with the first person;
identifying, by the server computer, based at least in part on the image data associated with the one or more images, a second computing device of the one or more computing devices, wherein the identifying includes recognizing, in the one or more images, a face of a second person associated with the second computing device;
determining, by the first server computer, based on (i) the indication of the gesture, (ii) the received identification information for the one or more computing devices, and (iii) the identification of the second computing device based on the image data:
that the gesture is associated with an intent to transfer information between the first computing device and the second computing device, and
which from among the first computing device and second computing device is an intended recipient computing device; and
sending, by the server computer, to the intended recipient computing device, content information associated with a user credential of the first person.

2. The method of claim 1, further comprising receiving, at the server computer, state information for at least first computing device and the second computing device.

3. The method of claim 1, wherein the image data associated with the one or more images comprises depth information.

4. The method of claim 1, further comprising identifying the second person based at least in part on recognizing the face of the second person.

5. (canceled)

6. The method of claim 1, wherein the first computing device is the server computer.

7. The method of claim 1, wherein the second computing device is the server computer.

8. The method of claim 1, wherein the indication of the gesture comprises an indication of an orientation of at least one of the one or more computing devices.

9. The method of claim 1, wherein the indication of the gesture comprises an indication of a sequence of one or more body positions.

10. The method of claim 1, wherein sending the content information comprises sending a link to content.

11. A system comprising:
a memory for storing data and computer-executable instructions;
an imaging device; and
at least one processor in communication with the imaging device, the at least one processor configured to access the memory, wherein the at least one processor is further configured to execute the computer-executable instructions to cause the system to:
receive identification information for one or more computing devices;
receive, from the imaging device, image data associated with one or more images, the image data including:
an indication of a current state of an environment of at least one of the one or more computing devices, and
an indication of a gesture performed by a first person;
associate, based at least in part on the image data associated with the one or more images, a first computing device of the one or more computing devices with the first person;
identify, based at least in part on the image data associated with the one or more images and the indication of the gesture, a second computing device of the one or more computing devices, wherein the identifying includes recognizing, in the one or more images, a face of a second person associated with the second computing device;
determine, based on (i) the indication of the gesture, (ii) the received identification information for the one or more computing devices, and (iii) the identification of the second computing device based at least in part on the image data:
that the gesture is associated with an intent to transfer information between the first computing device and the second computing device, and
which from among the first computing device and second computing device is an intended recipient computing device; and
send, to the intended recipient computing device, content information associated with a user credential of the first person.

12. (canceled)

13. The system of claim 11, wherein the at least one processor is further configured to execute the computer-executable instructions to cause the system to receive state information for at least one of the first computing device and the second computing device.

14. The system of claim 11, wherein the imaging device comprises a depth camera and the image data associated with the one or more images comprises depth information.

15. The system of claim 11, wherein the at least one processor is further configured to execute the computer-executable instructions to cause the system to:
identify the second person based at least in part on recognizing the face of the second person; and
associate the second computing device with the second person.

16. The system of claim 11, wherein the second computing device is associated with the first person.

17. (canceled)

18. (canceled)

19. The system of claim 11, wherein the indication of the gesture comprises an indication of an orientation of at least one of the one or more computing devices.

20. The system of claim 11, wherein the indication of the gesture comprises an indication of a sequence of one or more body positions.

21. The system of claim 13, wherein the content information comprises a link to content.

22. A non-transitory computer-readable medium storing instructions that, when executed by a one or more processors, cause a server computer to perform a method comprising:
receiving identification information for one or more computing devices capable of communication with the server computer;
receiving image data associated with the one or more computing devices, the image data including one or more indications of a current state of an environment of the one or more computing devices and an indication of a gesture performed by a first person;
associating, based at least in part on the image data associated with the one or more images, a first computing device of the one or more computing devices with the first person;
identifying, based at least in part on the image data associated with the one or more images, a second computing device of the one or more computing devices, wherein the identifying includes recognizing, in the one or more images, a face of a second person associated with the second computing device;
determining, based on (i) the indication of the gesture, (ii) the received identification information for the one or more computing devices, and (iii) the identification of the second computing device based at least in part on the image data:
that the gesture is associated with an intent to transfer information between the first computing device and the second computing device, and
which from among the first computing device and second computing device is an intended recipient computing device; and
sending, to the intended recipient computing device, content information associated with a user credential of the first person.

23. The non-transitory computer-readable medium of claim 22, further comprising receiving state information for at least one of the first computing device and the second computing device.

24. The non-transitory computer-readable medium of claim 22, further comprising identifying the second person based at least in part on recognizing the face of the second person.

25. (canceled)

26. The non-transitory computer-readable medium of claim 22, wherein the indication of the gesture comprises an indication of an orientation of at least one of the one or more computing devices.

27. The non-transitory computer-readable medium of claim 22, wherein the indication of the gesture comprises an indication of a sequence of one or more body positions.

28. The non-transitory computer-readable medium of claim 22, wherein sending the content information comprises sending a link to the content.
